(19) United States
(12) Patent Application Publication
(10) Pub. No.: US 2004/0115461 A1
(43) Pub. Date: Jun. 17, 2004

(54) Method of manufacturing the magnetic film having a multiple-axis

(75) Inventors: Chung Nam Whang, Seoul (KR); Gap Soo Chang, Tae Gu Gwang Yeok Shi (KR); Keun Hwa Chae, Seoul (KR); Kwang Ho Jeong, Seoul (KR)

Correspondence Address: BIRCH STEWART KOLASCH & BIRCH, PO BOX 747, FALLS CHURCH, VA, 22040-0747, US

(73) Assignee: PNT TECHNOLOGY, INC.

(21) Appl. No.: 10/728,763

(22) Filed: Dec. 8, 2003

Related U.S. Application Data
(62) Division of application No. 09/828,819, filed on Apr. 10, 2001, now abandoned.

(30) Foreign Application Priority Data
Apr. 12, 2000 (KR) 2000-019153

(51) Int. Cl. C03C 27/02; C03C 27/04

(52) U.S. Cl. 428/607; 428/630; 428/336; 428/694 TM; 427/526; 428/694 TS

(57) ABSTRACT

The present invention relates to a method of forming the magnetic film having a magnetic easy axis in a pre-formed area. Especially, the present invention related to a method of forming a multiple magnetic easy-axis in a pre-formed magnetic film. It is an object of the present invention to overcome the drawbacks of the conventional magnetic film and to achieve ultrahigh density of the unit recording cell using the magnetic film. It is another object of the present invention to suggest a method of forming a magnetic film and a magnetic film device in which the exchange interaction and the magneto-static interaction between the neighboring areas are eliminated in order to accomplish ultrahigh density for storing data. The present invention presents first, a method of forming a uniaxial magnetic easy axis on the magnetic film. The magnetic moments of the treated recording area having an easy axis are automatically aligned to the axis without an external magnetic field. This means that the magnetic moments of the treated recording area having an easy axis are strictly limited to the state in which the easy axis is same in magnitude but opposite in direction. Furthermore, this invention presents a extend method of forming a magnetic thin film having two neighboring areas with different direction of easy axis in respective area so that the exchange interaction between two neighboring areas is greatly reduced or eliminated.

### BACKGROUND OF THE INVENTION

1. Field of the Invention

The present invention relates to a method of forming a multiple magnetic easy-axis in a pre-formed magnetic film.

2. Description of the Related Art

Information Treatment technology has improved steadily during the last decade. Living in the information era, people need and demand in obtaining and storing information continues to grow and people eager for a storage media that will satisfy their needs. Therefore, the need for high density data storage media will increase rapidly and markets will look for manufacturers who have the technology.

There are two kind of storing systems. One is the primary memory made of semiconductor material such as DRAM, SDRAM, EPROM etc and the other is the secondary memory made of the magnetic material. The primary memory is used for storing data temporarily whereas the secondary memory is used for storing data for a long period of lime. In conventional method of storing data using the secondary memory; the data is stored in a magnetic media such as a magnetic tape, magnetic disk and magnetic drum or in an optical media such as a compact disk (CD) system. The disk type magnetic media is most widely used among these devices and it is more popular than the magnetic tape or the magnetic drum. A floppy disk driver (FDD) system, a hard disk driver (HDD) system and a magneto-optical disk driver (MOD) system are the storing systems in disk-type magnetic media. The conventional structure of the magnetic media is shown in FIG. 1. An under layer 13 including Cr. CrV, is deposited on a substrate 11 of Al/Mg which is made of alloy NiP seed layer (not shown) or glass with the thickness of 50 nm. A magnetic layer 15 including CoCrPt, CoCrPtB, FePtCr or CoNiCr is deposited on the under layer 13 with the thickness of 20 nm-30 nm. An overcoat layer 17 with the thickness of 10 nm including C:Nx and a lubricant layer 19 with the thickness of 2 nm are deposited sequentially thereon.

The conventional magnetic media has a continuous magnetic film (or magnetic layer 15). Each bit of information is stored by magnetizing a small region on the continuous thin magnetic film using a write head that provides a suitable magnetic field. A magnetic moment, location and an area of the small region present a bit of binary information and these must be defined precisely to allow a magnetic sensor, called a read head, to retrieve the written information. The conventional magnetic disk storage suffers several drawbacks that hinder realization of ultrahigh density storage. First, the magnetic moments of a continuous film have an infinite number of possibilities. Therefore, the write head must write very precisely in defining the magnetic moment, the location, and the area of each bit cell (which contains a bit of binary information) on the magnetic film. A slight error in doing so will not only create the error in the bit cell, but also could miswrite the neighboring bit cells, causing errors in reading. Second, a continuous magnetic film is very good at linking exchange interaction and magneto-static interaction between the bit cells. When the bit cells are very close to one another, writing of one bit cell could lead to writing of its neighbors because of the exchange interaction and magneto-static interaction between the bit cells. Third, the continuous magnetic film makes bit cells to have no physical boundaries among them making the reading and writing in a blind fashion. This means that the location of each bit cell is found by calculating the movements of the disk and by writing or reading heads, instead of physically sensing the location of the actual bit cell. Finally, the continuous magnetic film also makes the boundary of two bit cells with different ragged magnetization, creating noise when reading.

In general, the RAM (Random Access Memory) representing the primary memory is made of semiconductor. Therefore, price per unit capacity of the memory is very expensive compared to the hard disk representing the secondary memory. Besides, as almost all kinds of primary memory are volatile, information is erased when the electric power is turned off. There are non-volatile RAM such as SRAM (Static RAM) and FRAM (Flash RAM), however. they are more expensive than volatile DRAM (Dynamic RAM). Some developers introduced MRAM (Magnetic RAM) to the market in order to get a new type of non-volatile RAM with low cost. FIG. 2 shows the general structure of the MRAM. The basic principle of the MRAM comes from the MR (Magneto-resistance) head. A plurality of word line 61 running in one direction is arrayed with a gap. On the each word line 61, a plurality of magnetic bit cell 55 is arrayed. A plurality of bit line 63 running in the other direction crossing the word line 61 is arrayed on the magnetic bit cell 55. That is, the word line 61 and the bit line 63 cross each other in the three dimensional space, and the bit cell 55 is sandwiched at the crossing area of the word line 61 and the bit line 63. Here, the bit cell 55 comprises a first ferromagnetic layer 71 contacting the word line 61, a second ferromagnetic layer 73 contacting the bit line 63 and a tunneling barrier layer 77 inserted between the first 71 and second ferromagnetic layer 73. The first ferromagnetic layer 71 is magnetized in parallel direction in running direction of the word line 61. If the magnetized states of the first 71 and the second ferromagnetic layer 73 are the same, the bit cell represents “0” of digitized value because the current resistance among the bit cells 55 is low. Otherwise, the bit cell represents “1” as the current resistance is high. Therefore, when an electrical current is applied to one of word lines 61, different voltages are detected at the bit lines 63 according to the magnetized state of the bit cells 55. As a result, the stored data is retrieved. Electric current is applied to a selected word line 61 and a selected bit line 63 to write data and the second ferromagnetic layer 73 is magnetized in the reversed direction to the first ferromagnetic layer 71. The MRAM consists of magnetic materials for memory cells and semiconductor materials for driving the magnetic cells. In the MRAM, increasing the density of the magnetic cells is one of the important problems. The magnetic cells of the MRAM are isolated from one another. However, there are the same problem of the exchange interaction and the magneto-static interaction, when the magnetic cells are closely arrayed to increase the area density.

To achieve ultrahigh density magnetic storage, the drawbacks of the conventional magnetic storage mentioned above must be overcome. Many efforts were put in to overcome the drawbacks and in U.S. Pat. Nos. 5,956,216 and 6,146,755, the overcoming of the drawbacks is illustrated in particular. These two patents suggest discrete magnetic elements of magnetic materials. According to the patents, each discrete magnetic element is separated from other elements by nonmagnetic materials. The spacing is large enough so that exchange interaction between two neighboring elements is either greatly reduced or eliminated. Each magnetic element has a small size and a preferred shape anisotropy so the magnetic moments of each discrete magnetic element are automatically aligned to an axis of the element without an external magnetic field. Such a discrete magnetic element is called a single magnetic domain element. Cost for fabricating the magnetic film having such single domain according to these conventional inventions is very expensive. Accordingly, adaptation in the manufacturing lines and commercialization in the real market are difficult.

### SUMMARY OF THE INVENTION

In the present invention, a method of forming a uniaxial magnetic easy axis in a magnetic recording film and rotating a pre-formed easy axis in order to produce a magnetic film having a multiple easy axis.

It is an object of the present invention to overcome the drawbacks of the conventional magnetic data storage media and to achieve ultrahigh storage density. For that purpose, the present invention suggests a method of forming a magnetic film and a magnetic film device in which the exchange interaction and the magneto-static interaction between the neighboring areas are eliminated. The present invention presents first, a method of forming a magnetic easy axis in the magnetic film. Since the magnetic thin film has only one pre-formed easy axis, the magnetic moments of the recording area having a uniaxial easy axis are automatically aligned to the axis without an external magnetic field. This means that the magnetic moments of the magnetic area having an easy axis are strictly limited to the state in which the easy axis is same in magnitude but opposite in directions. In addition to a magnetic film having a pre-formed easy axis, this invention presents a method of controlling the direction of easy axis so that a invented method can produce magnetic thin film having two neighboring areas with different direction of easy axis in respective area so that the exchange interaction between the two neighboring areas is greatly reduced or eliminated.

### BRIEF DESCRIPTION OF THE DRAWINGS

FIG. 1 is the cross sectional view showing the general structure of the magnetic storage device such as hard disk drive system.

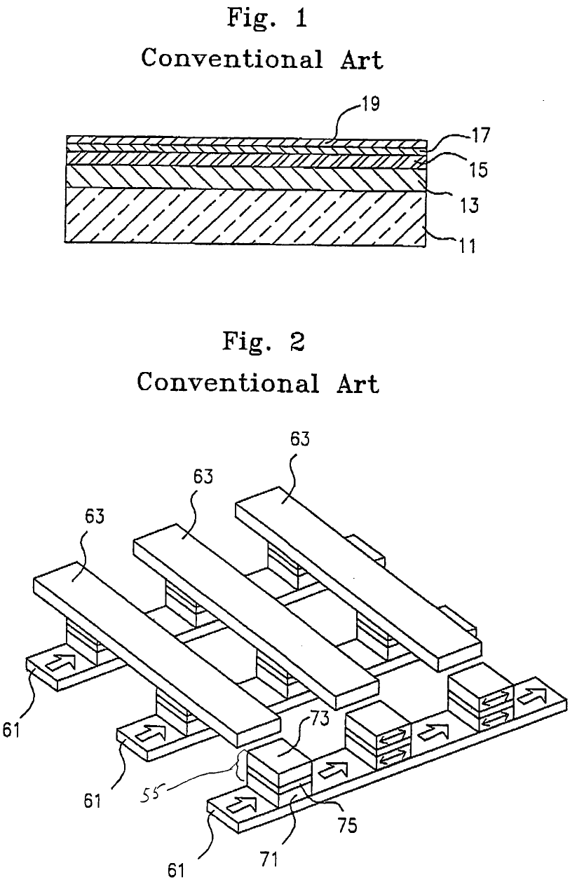

FIG. 2 is the perspective view showing the general structure of the magnetic RAM FIGS. 3a to 3e show an example of manufacturing method of a meta-stable CoPt alloy having dual easy axis according to the present invention.

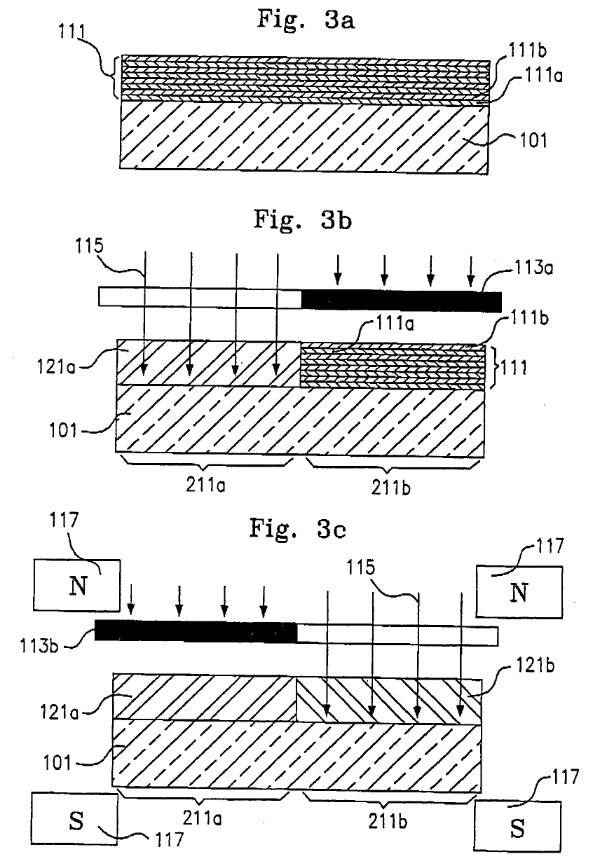

FIG. 4 shows the easy axis of the CoPt multilayer, the CoPt meta-stable alloy mixed by ion beam within a magnetic field.

FIGS. 5a to 5c show another example of manufacturing method of a ferromagnetic layer having dual easy axis according to the present invention.

FIGS. 6a-c shows the third example of manufacturing method of magnetic layer having dual easy axis using geometrical variation according to the present invention.

FIG. 7 shows the easy axis of the magnetic layer of CoPt multilayer, the magnetic layer treated by an ion beam at a first geometric condition and the magnetic layer treated by the ion beam at a second geometric condition.

### DETAILED DESCRIPTION OF THE PREFERRED EMBODIMENTS

In the present invention, a magnetic thin film having a ferromagnetic material such as Co, Ni, or Fe is treated with an ion beam having inert gas such as He, Ne, Ar, Xe, or. Kr to form an easy axis. Furthermore, when the ion beam is exposed to the magnetic film, a magnetic field is applied to make another easy axis of which crosses the easy axis formed without the magnetic field. Hereinafter, forming an easy axis or multiple easy axes will be explained in preferred embodiments referring to the attached drawings.

Preferred Embodiment 1

The FIGS. 3a to 3c show a method of forming a meta-stable magnetic thin film having dual easy axis by an ion beam mixing. In this preferred embodiment, the magnetic material has at least one of rare-earth materials such as Pt, Pd, Au, and Th and at least one of the transition metals such as Co, Fe, and Ni. The ion beam for mixing the rare-earth materials and the transition metals includes a selected ions among inert gases such as He, Ne, Ar, Xe and Kr.

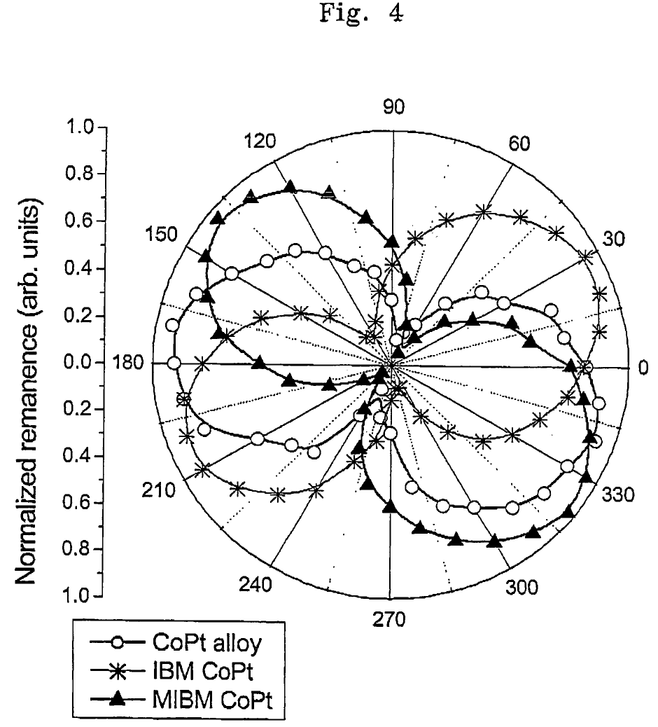

Referring to FIG. 3a, eight Pt layers 111a and eight Co layers 111b are deposited alternatively on a substrate 101 made of glass to form a CoPt multilayer 111 in a vacuum chamber (not shown in figure) with 8×10⁻⁷ torr. The thickness of each Pt layer 111a is 3.5 nm and that of each Co layer 111b is 4.5 nm so the thickness of the CoPt multilayer 111 is 64 nm. Here, an easy axis in the CoPt multilayer 111 of which direction is formed along to 170°-350° in the polar coordinate system is detected. As shown in FIG. 4, the white circles represent the direction of the easy axis of the CoPt multilayer 111. A first area 211a and a second area 211b are defined in the CoPt multilayer 111.

Referring to FIG. 3b, a second area 211b is covered with a first mask 113a such a stencil mask or a photo resist mask. Using an ion beam generator (not shown), an Ar⁺ ion beam 115 is injected into the first area 211a of the CoPt multilayer 111 where the energy of the ion beam is about 80 keV. Then the CoPt multilayer 111 is mixed to form a first meta-stable alloy layer 121. The first area 211a has a first easy axis having the direction of 200°-20° in the polar coordinate system (see FIG. 4). The asterisks in the FIG. 4 represent the direction of the first easy axis of the CoPt alloy in the first area 211a generated by a method described in FIG. 3b.

Referring to FIG. 3c, the first area 211a of the Co/Pt multilayer is covered with a second mask 113b (stencil mask or photo resist mask). A magnetic field is applied to surface of the Co/Pt multilayer in the perpendicular direction using magnets 117. An Ar⁺ ion beam 115 is injected into the second area 211b of the CoPt multilayer using an ion beam generator where the energy of the ion beam 115 is about 80 keV. Then the CoPt multilayer is mixed to form a second meta-stable alloy layer 121b. The second area 211b has a second easy axis having the direction of about 140°-320° in the polar coordinate system (see FIG. 4). As shown in FIG. 4, the black triangles represent the direction of the second easy axis of the CoPt alloy in the second area 211b generated by a method described in FIG. 3c. Therefore, according to FIGS. 3b, 3c, and 4, the difference in the direction between the first and second easy axis is about 60°.

Preferred Embodiment 2

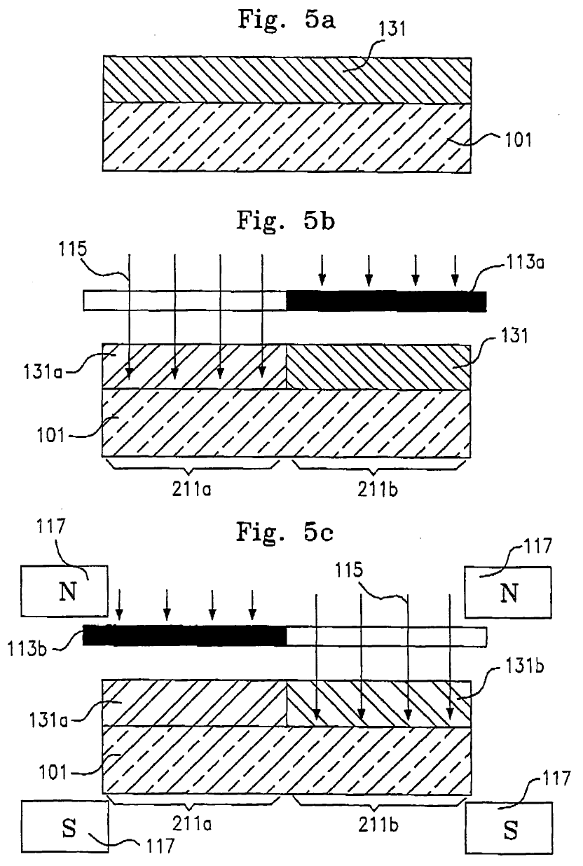

FIGS. 5a to 5c show another method of forming dual easy axis in magnetic recording film by an ion beam treating. From the method described in FIGS. 5a to 5c, In this preferred embodiment, It should be noted that the present invented method is not limited by the geometry of magnetic recording media. That is, this method can be applied not only to magnetic multilayers but also to magnetic alloy thin film. The magnetic material has at least one of ferromagnetic materials such as Co, Fe, and Ni. The ion beam treating the ferromagnetic material includes a selected one among inert gases such as He, Ne, Ar, Xe, and Kr.

Referring to FIG. 5a, a FePt (or CoPt, NiPt) alloy thin film is deposited on a substrate 101 to form a magnetic (or ferromagnetic) layer 131 with the thickness of 20-100 nm in a vacuum chamber (not shown) with 8×10⁻⁷ torr.

Referring to FIG. 5b, a first area 211a and a second area 211b are defined at the magnetic layer 131. The second area 211a is covered with a first mask 113a such as a stencil mask or a photo resist mask. An Ar⁺ ion beam 115 is injected into the first area 211a of the magnetic layer 131 using an ion beam generator (not shown) where the energy of the ion beam 115 is about 80 keV. Then a first magnetic layer 131a is formed in the first area 211a with a first easy.

Next, the first area 211a of the magnetic layer 131 is covered with a second mask 113b (stencil mask or photo resist mask). A magnetic field is applied to the magnetic layer with the perpendicular direction to the plane of the magnetic layer using magnets 117. An Ar₊ ion beam 115 is injected into the second area 211b of the magnetic layer using an ion beam generator (not shown) where the energy of the ion beam 115 is about 80 keV. Then a second magnetic layer 131b is formed in the second area 211b with a second easy.

Preferred Embodiment 3

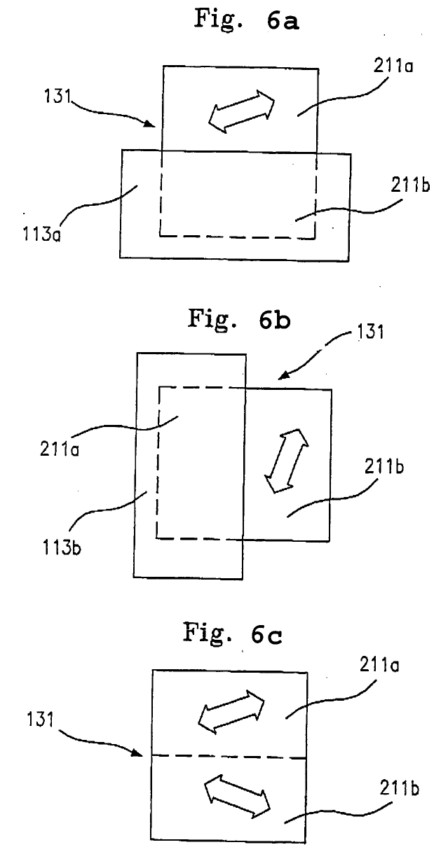

FIGS. 6a to 6c show the method of forming a dual easy axis in magnetic recording film by ion beam treating ‘without magnetic field’. In this preferred embodiment, the magnetic material has at least one of ferromagnetic materials such as Co, Fe, and Ni. The ion beam treating the ferromagnetic material includes a selected one among inert gases such as He, Ne, Ar, Xe, and Kr.

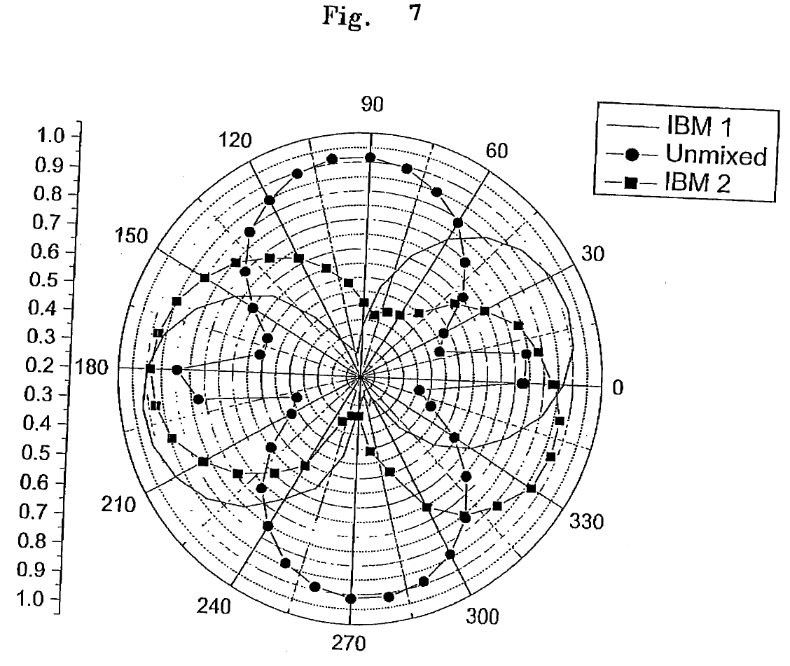

A magnetic material (FePt, CoPt, or NiPt) is deposited on a substrate (not shown) on a substrate (not shown) to form a magnetic (or ferromagnetic) layer 131 with the thickness of 20-100 nm in a vacuum chamber (not shown) with 8×10⁻⁷ torr. An easy axis in the Co/Pt layer which is formed along the direction of 100°-280° in the polar coordinate system and which is detected (see FIG. 9). As shown in FIG. 7, the black circles represent the direction of the easy axis of the CoPt magnetic layer.

Referring to FIG. 6a, a first area 211a and a second area 211b are defined at the magnetic layer 131. The second area 211b is covered with a first mask 113a such as a stencil mask or a photo resist mask. An Ar⁺ ion beam is injected into the first area 211a of the magnetic layer 131 using an ion beam generator (not shown) in which the energy of the ion beam is about 80 keV. Then a first easy axis having the direction from about 20° to 200° in the polar coordinate system is formed in the area 211a. The arrow mark represents the direction of the easy axis. As shown in FIG. 9, the normal line represents the direction of the first easy axis of the magnetic layer 131.

Next, the magnetic layer 131 is set to rotate in about 90° in counter clockwise direction, referring to FIG. 6b. The first area 211a of the magnetic layer 131 is covered with a second mask 113b (stencil mask or photo resist mask). An Ar⁺ ion beam is injected into the first area 211a of the magnetic layer 131 using an ion beam generator (not shown) in which the energy of the ion beam is about 80 keV. Then a first easy axis having the direction from about 160° to 340° in the polar coordinate system is formed in the second area 211b. The arrow mark represents the direction of the easy axis. As shown in FIG. 7, the black squares represent the direction of the second easy axis of the magnetic layer 131 in the second area 211b. Therefore, the difference in the direction between the first and second easy axis is about 40°.

Finally, the magnetic layer 131 has two areas, the first area 211a and the second area 211b. Each area has different magnetic easy axis referring to the FIG. 6c. In this embodiment, making of dual easy axis in one magnetic film in which the ion beam treatment is used in different setting of the magnetic film without magnetic field is shown. Therefore, a magnetic thin film can have multi easy axis by controlling the geometric condition of the ion treatment.

In conclusion, the present invention suggests a method of producing a magnetic film (or area) which allows its magnetization to one or the other of two magnetization values which differs in magnetization vector directions and which has substantially equal magnetization vector magnitude in the absence of an external magnetic field. In this invention, the easy axis is formed neither by single-domain construction nor by shape anisotropy, but formed by ion treatment. This suggests that the direction of the easy axis can be controlled freely by adjusting the condition of ion treatment. Furthermore, the present invention also represents the method of producing a magnetic thin film having neighboring areas in which the easy axis is in different direction and in which the physical boundaries are formed (Magnetic recording device with dual easy axis). As a result, the magnetic properly of one area does not influence that of the neighboring area. Applying the present invention to the conventional magnetic storage device, the area density can be increased and more advanced storage device can be realized.

What is claimed is:

1. A method of manufacturing a magnetic film comprising steps of:
forming a magnetic layer on a substrate; defining a first area and a second area of the magnetic layer;
treating the first area of the magnetic layer with an ion bean to form a first area having a first direction; and
treating the second area of the magnetic layer with an ion beam in a magnetic field to form a second easy axis having a second direction.

2. The method of manufacturing a magnetic film of claim 1 wherein the magnetic layer comprises an rare earth material selected at least one of Pt, Pd, Au, and Th.

3. The method of manufacturing a magnetic film of claim 1 wherein the angle difference between the direction of the first easy axis and that of the second easy axis is from 60° to 90°.

4. The method of manufacturing a magnetic film of claim 1 wherein the magnetic layer comprises a transition metal selected at least one of Co, Ni, and Fe.

5. The method of manufacturing a magnetic film of claim 1 wherein the beam comprises an inert gas selected at least one of He, Ne, Ar, Xe, and Kr.

6. A method of manufacturing a magnetic film comprising steps of:
forming a magnetic layer on a substrate; and
applying an ion beam into a selected area of the magnetic layer to form a first easy axis having a first direction.

7. The method of manufacturing a magnetic film of claim 6 further comprising steps of:
applying a magnetic field to the magnetic film and applying an ion beam into another selected area of the magnetic layer to form a second easy axis having a second direction.

8. The method of manufacturing a magnetic film of claim 6 wherein the magnetic layer comprises a transition metal selected at least one of Co, Ni, and Fe.

9. The method of manufacturing a magnetic film of claim 6 wherein the beam comprises an inert gas selected at least one of He, Ne, Ar, Xe, and Kr.

10. A method manufacturing a magnetic film comprising steps of:
forming a magnetic layer on a substrate; and
treating the magnetic layer with an ion beam to form an easy axis having a direction.

11. The method of manufacturing a magnetic film of claim 10 wherein the magnetic layer comprises a transition metal selected at least one of Co, Ni, and Fe.

12. A method manufacturing a magnetic film comprising steps of:
forming a magnetic layer on a substrate;
applying a magnetic field to the magnetic film; treating the magnetic layer with an ion beam to form an easy axis having a direction.

13. The method of manufacturing a magnetic film of claim 12 wherein the magnetic layer comprises a transition metal selected at least one of Co, Ni, and Fe.

14. A method manufacturing a magnetic film comprising steps of:
forming a magnetic layer on a substrate;
covering the magnetic layer with a first mask opening a first area;
treating the first area with an ion beam to form an first easy axis;
rotating the magnetic layer in some degree;
covering the magnetic layer with a second mask opening a second area; and
treating the second area with an ion beam to form an second easy axis.

15. A method manufacturing a magnetic film comprising steps of:
forming a magnetic layer on a substrate;
covering the magnetic layer with a first mask opening a first area;
treating the first area with an ion beam in a magnetic field to form an first easy axis;
rotating the magnetic layer in some degree;
covering the magnetic layer with a second mask opening a second area; and
treating the second area with an ion beam in a magnetic field to form an second easy axis.
